(19) United States
(12) Patent Application Publication
(10) Pub. No.: US 2025/0368001 A1
(43) Pub. Date: Dec. 4, 2025

(54) AIR QUALITY CONTROL APPARATUS AND METHOD FOR A VEHICLE

(71) Applicants: HYUNDAI MOTOR COMPANY, Seoul (KR); KIA CORPORATION, Seoul (KR); DOOWON CLIMATE CONTROL CO.,LTD, Asan-si (KR)

(72) Inventors: Myung Hun Kang, Hwaseong-si (KR); Ui Jin Jeong, Hwaseong-si (KR); Dong Hyeop Kim, Hwaseong-si (KR); Bong Kyung Son, Hwaseong-si (KR); Dong Won Yeon, Hwaseong-si (KR); Kang Woo Nam, Cheonan-si (KR); Jin Kyu Choi, Asan-si (KR)

(73) Assignees: HYUNDAI MOTOR COMPANY, Seoul (KR); KIA CORPORATION, Seoul (KR); DOOWON CLIMATE CONTROL CO.,LTD, Asan-si (KR)

(21) Appl. No.: 18/937,783

(22) Filed: Nov. 5, 2024

(30) Foreign Application Priority Data
May 28, 2024 (KR) 10-2024-0068992

(51) Int. Cl. B60H 1/00

(52) U.S. Cl. CPC B60H 1/008; B60H 1/00785; B60H 1/00849; B60H 1/00864

(57) ABSTRACT

A vehicle air quality control apparatus includes a VOC sensor that measures a concentration of volatile organic compounds inside a vehicle, a CO₂ sensor that measures a concentration of CO₂ inside the vehicle, a PM sensor that measures a concentration of particulate matter inside the vehicle, an ADS sensor that measures a humidity level inside the vehicle, and a control unit that calculates an opening degree of an intake door, an operating level of a blower motor, and an operating level of an air conditioner, based on data measured from the sensors, and controls the opening degree of the intake door, the operating level of the blower motor, and the operating level of the air conditioner, according to priority of the opening degree of the intake door, the operating level of the blower motor, and the operating level of the air conditioner.

### CROSS-REFERENCE TO RELATED APPLICATION

This application claims, under 35 U.S.C. § 119(a), the benefit of and priority to Korean Patent Application No. 10-2024-0068992, filed on May 28, 2024, the entire contents of which are incorporated herein by reference.

### BACKGROUND

### (a) Technical Field

The present disclosure relates to a vehicle air quality control apparatus and a method therefor, and more particularly, to a vehicle air quality control apparatus and a method therefor, capable of controlling an operating level of a blower, an opening degree of an intake door, and an operation of an air conditioner.

### (b) Background Art

A heating, ventilation, air conditioning (HVAC) system for a vehicle is an apparatus for cooling or heating air in introducing outdoor air into the vehicle or circulating indoor air. The HVAC system is provided with an evaporator for cooling and a heater core for heating inside an air conditioner case. The HVAC system is configured to selectively send air cooled or heated by the evaporator or the heater core to various parts inside the vehicle using a blow mode switching door.

Such an HVAC system typically includes an air conditioner case, a blower, an evaporator, a heater core, and a temperature control door.

An intake door is provided on an inlet side of the air conditioner case. A defrost vent, a face vent, and a floor vent whose opening degrees are controlled by a mode door are provided on an outlet side of the case. The opening degree of the intake door is controlled to allow outdoor air to flow into the air conditioner case. Further, the blower is connected to an air inlet of the air conditioner case and performs the function of blowing indoor or outdoor air. The evaporator and the heater core are sequentially provided inside the air conditioner case. The temperature control door is provided between the evaporator and the heater core, and controls opening degrees of a cold air flow path that bypasses the heater core and a warm air flow path (P2) that passes through the heater core. The air conditioner provides mixed air from both the cold air flow path and the warm air flow path, combining the functions of the evaporator and the heater core.

Further, the air conditioner includes a sensor unit for performing HVAC control. The sensor unit may include a volatile organic compound (VOC) sensor that measures volatile organic compounds, an auto defogging system (ADS) sensor that measures the temperature and humidity of the vehicle, a CO₂ sensor that measures the concentration of CO₂ inside the vehicle, and a particulate matter (PM) sensor that measures the amount of dust particles outside the vehicle.

However, when controlling the blower, the intake door, and the air conditioner based on data received from the sensor unit, conflicting control commands may arise, necessitating a priority decision to control the blower, the intake door, and the air conditioner.

The above information disclosed in this Background section is provided only to enhance understanding of the background of the disclosure and therefore it may contain information that does not form the prior art that is already known to a person of ordinary skill in the art.

### SUMMARY

The present disclosure has been made in an effort to solve the above-described problems associated with prior art, and an object of the present disclosure is to provide a vehicle air quality control apparatus and method for prioritizing controls of a blower, an intake door, and an air conditioner on the basis of data received from a plurality of sensor units.

Another object of the present disclosure is to provide a vehicle air quality control apparatus and method for determining priority or a reference for selecting control commands among conflicting control commands.

The objects of the present disclosure are not limited to the objects mentioned above, and other objects of the present disclosure that are not mentioned may be understood by the following description and may be more clearly understood by the embodiments of the present disclosure. Additionally, the objects of the present disclosure may be realized by means and combinations thereof as indicated in the claims.

In one aspect, the present disclosure provides an air quality control apparatus for a vehicle. The apparatus includes: a VOC sensor that measures a concentration of volatile organic compounds inside the vehicle, a CO₂ sensor that measures a concentration of CO₂ inside the vehicle, a PM sensor that measures a concentration of particulate matter inside the vehicle, and an ADS sensor that measures a humidity level inside the vehicle. The air quality control apparatus further includes a control unit that calculates an opening degree of an intake door, an operating level of a blower motor, and an operating level of an air conditioner, based on data measured from the ADS sensor, the VOC sensor, the CO₂ sensor, and the PM sensor. The control unit controls the opening degree of the intake door, the operating level of the blower motor, and the operating level of the air conditioner, according to priority of the opening degree of the intake door, the operating level of the blower motor, and the operating level of the air conditioner.

In an embodiment, when controlling the opening degree of the intake door selected according to the priority, the control unit may set the priority in order of the ADS sensor, the VOC sensor, the CO₂ sensor, and the PM sensor to control the opening degree of the intake door.

In another embodiment, when controlling the opening degree of the intake door, the control unit may sequentially determine the opening degree of the intake door in the order of the ADS sensor, the VOC sensor, the CO₂ sensor, and the PM sensor to perform control for allowing the intake door to have a maximum opening degree.

In still another embodiment, when controlling the operating level of the blower motor selected according to the priority, the control unit may perform control for maximizing the operating level of the blower motor on the basis of the data measured from the ADS sensor, the VOC sensor, the CO₂ sensor, and the PM sensor.

In yet another embodiment, when controlling the operation of the air conditioner selected according to the priority, the control unit may operate the air conditioner in a case where there is at least one air conditioner-on request on the basis of the data measured from the ADS sensor, the VOC sensor, and the PM sensor.

In still yet another embodiment, when determining the priority of the data measured from the ADS sensor, the VOC sensor, the CO₂ sensor, and the PM sensor, the control unit may index the data measured from the ADS sensor, the VOC sensor, the CO₂ sensor, and the PM sensor, and control the opening degree of the intake door, the operating level of the blower motor, and an on-off of the air conditioner according to the priority of the opening degree of the intake door, the operating level of the blower motor, and the operating level of the air conditioner.

In another aspect, the present disclosure provides a vehicle air quality control method. The method includes: operating, by a control unit, an HVAC system of a vehicle, operating a sensor unit; receiving, by the control unit, data on a concentration of volatile organic compounds, a concentration of CO₂ inside the vehicle, a concentration of particulate matter inside the vehicle, and a humidity level inside the vehicle from the sensor unit; and controlling, by the control unit, a blower, an air conditioner, and an opening degree of an intake door based on the received data.

In an embodiment, operating the sensor unit may include performing initialization of the sensor unit.

In another embodiment, controlling the blower, the air conditioner, and the opening degree of the intake door on the basis of the received data, may include: calculating, by the control unit, control values of the blower, the air conditioner, and the opening degree of the intake door on the basis of the data received from the sensor unit; and controlling, by the control unit, the blower, the air conditioner, and the opening degree of the intake door according to priority of the calculated control values.

In still another embodiment, controlling the blower, the air conditioner, and the opening degree of the intake door according to the priority of the calculated control values, may include: sequentially determining control amounts of a blower motor respectively calculated on the basis of data received from an ADS sensor, a VOC sensor, a CO₂ sensor, and a PM sensor, and performing control for allowing the blower motor to have a maximum operating level.

In yet another embodiment, controlling the blower, the air conditioner, and the opening degree of the intake door according to the priority of the calculated control values, may include: sequentially determining the opening degree of the intake door according to priority of an ADS sensor, a VOC sensor, a CO₂ sensor, and a PM sensor, and performing control for providing the opening degree of the intake door according to the priority.

In still yet another embodiment, controlling the blower, the air conditioner, and the opening degree of the intake door according to the priority of the calculated control values may include: operating the air conditioner in a case where there is at least one air conditioner-on request on the basis of data received from the ADS sensor, the VOC sensor, and the PM sensor.

Other aspects and embodiments of the disclosure are discussed below.

### BRIEF DESCRIPTION OF THE DRAWINGS

The above and other features of the present disclosure are described in detail with reference to certain embodiments thereof illustrated the accompanying drawings which are given hereinbelow by way of illustration only, and thus are not limitative of the present disclosure, and wherein:

FIG. 1 is a block diagram illustrating a configuration of a vehicle air quality control apparatus according to an embodiment of the present disclosure;

FIG. 2 is a flowchart of a vehicle air quality control method according to an embodiment of the present disclosure; and

FIG. 3 is a block diagram illustrating a priority determination process in a vehicle air quality control method according to an embodiment of the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes should be determined in part by the particular intended application and use environment.

In the figures, reference numbers refer to the same or equivalent parts of the present disclosure throughout the several figures of the drawing.

### DETAILED DESCRIPTION

Hereinafter, reference is made in detail to various embodiments of the present disclosure, which are illustrated in the accompanying drawings and described below. While the present disclosure is described in conjunction with some embodiments, it should be understood that the present description is not intended to limit the disclosure to the specific embodiments. The embodiments are provided to more completely describe the present disclosure to those having ordinary skill in the art.

In addition, terms such as “ . . . unit” and “ . . . module” used in the present disclosure refer to a unit that processes at least one function or operation, which may be implemented through hardware (e.g., a processor), software, or a combination of hardware and software.

The terminology used herein is for the purpose of describing particular embodiments only and is not intended to limit the embodiments of the disclosure. As used herein, the singular forms “a”, “an”, and “the” are intended to include the plural forms as well, unless the context clearly indicates otherwise.

Although the terms “first”, “second”, etc. may be used herein to describe various elements, these elements should not be limited by these terms. These terms are only used to distinguish one element from another. For example, a first element may be termed a second element, and, similarly, a second element may be termed a first element, without departing from the scope of the present disclosure.

When a component, device, element, or the like of the present disclosure is described as having a purpose or performing an operation, function, or the like, the component, device, or element should be considered herein as being “configured to” meet that purpose or to perform that operation or function.

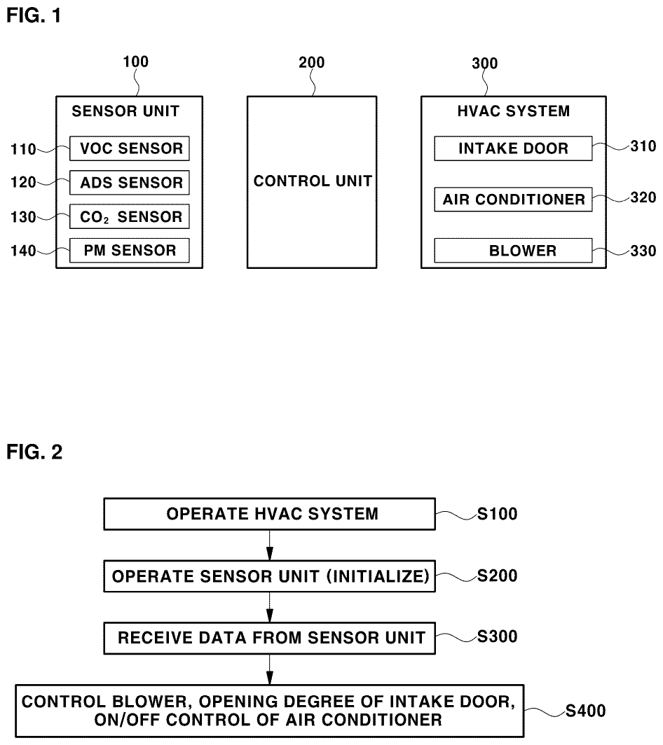

Referring to FIG. 1, a control unit 200 may be an electronic control unit (ECU) of an ECU level, which comprehensively controls multiple electronic devices used in an automobile. For example, the control unit 200 may control both processors at a processor level and controllers at a controller level. The control unit 200 may receive sensing data from the processors, generate control commands for controlling the controllers according to situations, and transmit the control commands to the controllers. In this description, a configuration in which the ECU level is higher than the processor level is shown for convenience of explanation, but a configuration in which one processor among the processors belonging to the processor level serves as the ECU, or two processors serve as the ECU in combination may be used.

Hereinafter, various embodiments of the present disclosure are described with reference to the accompanying drawings. Reference numbers refer to the same or equivalent parts of the present disclosure throughout the several drawings.

As shown in FIG. 1, a vehicle air quality control apparatus according to an embodiment of the present disclosure includes an HVAC system 300. The vehicle air quality control apparatus also includes an intake door 310, a blower 330, and an air conditioner 320, as control targets. The control unit 200 may determine control variables of the intake door 310, the blower 330, and the air conditioner 320 based on data received from a sensor unit 100.

The sensor unit 100 may be provided as an integrated sensor located in a vehicle. Fully automatic temperature control (FATC) may be implemented through the control unit 200 in conjunction with the sensor unit 100.

The FATC includes the control unit 200 controlling the opening degree of the intake door 310 to allow outdoor air to flow into an air conditioner case. Further, the air conditioner 320 is configured to enable dehumidification, cooling and heating by operation of an evaporator and a heater core to implement FATC. In addition, for FATC, the blower 330 may be configured to set a speed of air provided through the air conditioner case.

The sensor unit 100 includes a VOC sensor 110, a CO₂ sensor 130, an ADS sensor 120, and a PM sensor 140.

The VOC sensor 110 may measure the concentration of volatile organic compounds flowing into the HVAC system 300. Further, when a coolant in the heater core is equal to or higher than a certain temperature, for example, about 80° C., volatile organic compounds (VOCs) are converted into carbon dioxide (CO₂) through oxidation. In other words, in a case where the temperature of the heater core increases due to the engine coolant after starting the vehicle, the increased heat of the heater core is transferred to an oxidation catalyst part to increase the temperature of the oxidation catalyst, thereby converting surrounding VOCs into CO₂. In this case, the amount of CO₂ generated through oxidation is so small that it does not harm the human body.

The control unit 200 may effectively remove VOCs by monitoring the concentration of VOCs through data received from the VOC sensor 110 and adjusting the opening degree of the intake door 310.

The oxidation catalyst part may be provided on an upstream surface of the heater core in an air flow direction. As the oxidation catalyst part is provided upstream of the heater core, the air flowing through the heater core first comes into contact with the oxidation catalyst part to cause oxidation, thereby removing the VOC, which increases a contact rate with air to further improve VOC removal efficiency.

In addition, the heater core is provided with fins for heat exchange with the air passing therethrough. The heater core has pipes through which the coolant flows in and out, and the heater core has a plurality of tubes connected to a coolant header tank. The fins are formed between the respective tubes for heat exchange with air. The oxidation catalyst part may be provided as a coating on each fin. With this configuration, the contact rate with air may be maximized and thus further improve the removal efficiency of VOCs in air.

Furthermore, the control unit 200 determines whether the detected temperature is a temperature at which VOCs can be removed in a case where the detected VOC concentration is equal to or higher than a reference value. As a result of the determination, if the detected temperature is the temperature at which VOCs can be removed, the control unit 200 determines whether the indoor temperature needs to be corrected by comparing the detected temperature with a set temperature (or a reference temperature). In addition, if it is determined that the indoor temperature needs to be corrected, the control unit 20 decreases the temperature of the evaporator, and then, controls the operation of the intake door 310. In a case where it is determined that the indoor temperature does not need to be corrected, the control unit 200 immediately controls the operation of the intake door 310.

A vehicle air quality control method according to an embodiment of the present disclosure includes: a step of comparing the concentration of VOCs in the air around the heater core with a reference concentration; and a step of comparing, in a case where the detected VOC concentration is equal to or higher than the reference value, the temperature of the heater core with a reference temperature to determine whether the temperature of the heater core is a temperature at which VOCs can be removed. The vehicle air quality control method further include: a step of comparing, in a case where the temperature of the heater core is the temperature at which VOCs can be removed, the detected temperature with a set temperature to determine whether the indoor temperature needs to be corrected; and a step of controlling the operation of the intake door 310 after decreasing the temperature of the evaporator in a case where it is determined that the indoor temperature needs to be corrected and immediately controlling the operation of the intake door 310 in a case where it is determined that the indoor temperature does not need to be corrected.

In other words, in order to decrease the VOC concentration using the vehicle HVAC system 300, the control unit 200 may calculate a command value for opening the intake door 310, and may calculate a command value for requesting the operation of the air conditioner 320 (heater core and evaporator).

As an example, the CO₂ sensor 130 may measure the concentration of carbon dioxide inside the vehicle.

The control unit 200 may control the opening degree of the intake door 310 by controlling an actuator of the intake door 310 on the basis of data received from the CO₂ sensor 130. In other words, the actuator of the intake door 310 may operate the intake door 310 that is rotated between an indoor air inlet connected to an indoor air flow path of the vehicle and an outdoor air inlet connected to an outdoor air flow path of the vehicle and selectively opens and closes the indoor air inlet and the outdoor air inlet. The actuator of the intake door 310 may be operated in performing air circulation mode switching according to a determination result of an indoor air condition of the vehicle by the control unit 200.

The control unit 200 may determine the vehicle's indoor air condition on the basis of the concentration of CO₂ measured by the CO₂ sensor 130, and may automatically perform the air circulation mode switching on the basis of the determination result.

Here, in the air circulation mode, the control unit 200 performs control for increasing the opening degree of the intake door 310 to draw in outdoor air, and also performs control for operating the air conditioner 320 and increasing the operating level of the blower 330.

According to the present embodiment, in determining the air condition inside the vehicle on the basis of the CO₂ concentration received from the CO₂ sensor 130 and a preset reference value, the reference value may be adjusted according to a user's set mode. For example, if the user's set mode is a pollutant minimization priority mode, the control unit 200 sets a reference value from “good” to “normal” in the pollutant minimization priority mode to be lower than a reference value from “good” to “normal” in a CO₂ minimization priority mode (i.e., strengthens the determination standard).

As an example, an auto defogging system (ADS) sensor (hereinafter, referred to as an ADS sensor) measures the humidity level inside the vehicle, and transmits the result to the control unit 200. The control unit 200 controls the intake door 310 to prevent moisture from being generated on glass inside the vehicle.

The control unit 200 controls the intake door 310 so that the intake door 310 has an opening degree for increasing an outdoor air inflow rate in a region where the humidity data received from the ADS sensor 120 is high, and controls the intake door 310 so that the intake door 310 has an opening degree for decreasing the outdoor air flow rate in a region where the humidity data is low.

Further, air conditioning control for automatic defogging is performed on the basis of the moisture data received from the ADS sensor 120. To this end, the control unit 200 determines whether a predetermined auto defogging entry condition (moisture occurrence condition) is satisfied on the basis of signals received from the temperature sensor and the humidity sensor, and controls the HVAC system 300 in an auto defogging mode in a case where the auto defogging entry condition is satisfied.

In other words, in the auto defogging mode, the control unit 200 controls the opening degree of the intake door 310 to sequentially perform switching to an outdoor air mode, increasing the air volume of the blower 330, and operating the air conditioner 320, and continuously performs the above control until an auto defogging release condition is satisfied.

For example, the control unit 200 performs switching to the outdoor air mode under the auto defogging entry condition, but in a case where the auto defogging release condition is not satisfied even after entering the outdoor air mode and lapse of a predetermined time, the control unit 200 may perform switching to the next step, i.e., a defrost mode for discharging air through a defrost vent.

In addition, the control unit 200 increases the air volume of the air conditioning blower 330 in a case where the auto defogging release condition is not satisfied in the defrost mode, and operates the air conditioner 320 in a case where the auto defogging release condition is not satisfied even by increasing the air volume of the air conditioning blower 330.

In this way, in a case where the auto defogging entry condition is satisfied through the detection of temperature and humidity inside the vehicle, the air conditioning control is performed by automatically performing the respective steps until the auto defogging release condition is satisfied to defrost and prevent moisture generation.

The air conditioning control is most effective when operating the air conditioner 320 for defogging, but fuel efficiency may deteriorate in a case where the air conditioner 320 is operated unconditionally. Accordingly, the operation of the air conditioner 320 is minimized and performed only when absolutely necessary for defogging, thereby achieving the purpose of defogging and contributing to improving fuel efficiency.

Further, the PM sensor 140 of the present embodiment may measure the quantity of particulate matter inside the vehicle. Here, in order to remove particulate matter introduced into the vehicle, the control unit 200 switches the intake door 310 to an indoor air mode, determines whether the intake door 310 is completely closed to block the inflow of outdoor air, and then, increases the operating level of the blower 330. In a case where the operating level of the blower 330 is raised in a state where the intake door 310 is not completely closed, outdoor particulate matter may flow into the inside of the vehicle. Accordingly, the operating level of the blower 330 is maintained at a current level until the intake door 310 is completely closed, and is increased after confirming that the intake door 310 is completely closed.

As the operating level of the blower 330 increases, a flow rate of air passing through an air filter increases, so that particulate matter inside the vehicle is quickly removed, but noise tends to increase. Accordingly, it is desirable to set the operating level of the blower 330 so as to efficiently remove indoor particulate matter while minimizing the noise increase. This operating level of the blower 330 may be determined as a value derived through tests and evaluations under actual vehicle conditions.

In addition, the control unit 200 may determine whether to operate the air conditioner 320 while controlling the operating level of the blower 330, in response to the amount of indoor particulate matter. As a condition for determining whether to turn on the air conditioner 320, the concentration of particulate matter inside the vehicle is used. Specifically, in a case where both the concentration of particulate matter of PM 10 and the concentration of particulate matter of PM 2.5 within the vehicle are at “very bad” levels, the air conditioner 320 is turned on.

In this way, the VOC sensor 110, the CO₂ sensor 130, the ADS sensor 120, and the PM sensor 140 that form the sensor unit 100 transmit the measured data to the control unit 200, and the control unit 200 may calculate control commands for the HVAC system 300 on the basis of the sensor data. In calculating the control commands on the basis of the data, the control unit 200 may calculate an independent control command for the data received from each sensor. The calculated control command is selected by the control unit 200 to control a control target.

In addition, the target of the control command selected by the control unit 200 may include the operating level of the blower 330, the opening degree of the intake door 310 and the operating conditions of the air conditioner 320 of the HVAC system 300.

Further, the control unit 200 may determine the air condition within the vehicle as at least one of “good”, “normal”, or “bad” on the basis of the pollutant concentration measured by the sensor unit 100. For example, the control unit 200 may determine the air condition within the vehicle as at least one of “good”, “normal”, or “bad” according to a preset standard (e.g. WHO international standards) on the basis of the concentration of pollutants, and further, may determine the air condition within the vehicle as at least one of “safe”, “caution”, or “danger” on the basis of the concentration of carbon dioxide. In addition, the control unit 200 may determine the air condition within the vehicle as at least one of “safe”, “caution”, or “danger” according to a preset standard (e.g., Standards for Maintaining Indoor Air Quality) on the basis of the data measured from the sensor unit 100.

In addition, the control unit 200 may calculate a comprehensive air quality index (CAI) on the basis of the data received from each sensor, and may determine the comprehensive air quality as at least one of “safe”, “caution”, or “danger” on the basis of the indices.

FIG. 2 is a flowchart illustrating a vehicle air quality control method according to an embodiment of the present disclosure.

According to an embodiment of the present disclosure, the vehicle air quality control method includes a step of operating the HVAC system 300 of a vehicle (an operation S100), and a step of operating (initializing) the sensor unit 100 (an operation S200).

As the sensor unit 100 is operated, the control unit 200 determines the concentration of volatile organic compounds, the concentration of carbon dioxide, the concentration of particulate matter, and the humidity level inside the vehicle, using the plurality of sensors of the sensor unit 100 (in an operation S300).

Here, the sensor unit 100 includes the VOC sensor 110 that measures the concentration of volatile organic compounds inside the vehicle, the CO₂ sensor 130 that measures the concentration of carbon dioxide inside the vehicle, the PM sensor 140 that measures particulate matter inside the vehicle, and the ADS sensor 120 that measures the humidity level inside the vehicle.

The control unit 200 controls the blower 330, the air conditioner 320, and the opening degree of the intake door 310 on the basis of data received from the sensor unit 100 (an operation S400).

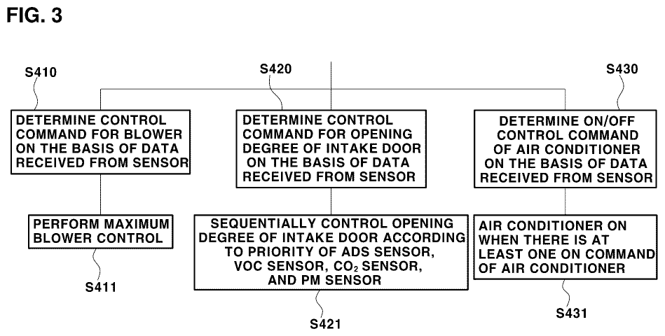

FIG. 3 illustrates a process of controlling the blower 330, the air conditioner 320, and the opening degree of the intake door 310 on the basis of the data received from the sensor unit 100, by the control unit 200.

First, the control unit 200 calculates control commands for the blower 330, the air conditioner 320, and the opening degree of the intake door 310 on the basis of the data received from the plurality of sensors.

Then, the control unit 200 compares control commands for a certain control target among the control commands calculated on the basis of the data received from the respective sensors to determine priority.

For example, in order to control the blower 330, the control unit 200 compares control commands for the blower 330 calculated through the VOC sensor 110, the CO₂ sensor 130, the PM sensor 140, and the ADS sensor 120 (an operation S410), and selects a control command having the largest operating level of the blower 330 among the compared control commands to operate the blower 330 (an operation S411).

Further, in order to control the air conditioner 320, the control unit 200 compares on/off control commands for the air conditioner 320 calculated through the VOC sensor 110, the CO₂ sensor 130, the PM sensor 140, and the ADS sensor 120 (S430), and turns on the air conditioner 320 in a case where there is at least one on command of the air conditioner 320 among the compared control commands (an operation S431).

In addition, in order to control the opening degree of the intake door 310, the control unit 200 compares control commands for the opening degree of the intake door 310 calculated through the VOC sensor 110, the CO₂ sensor 130, the PM sensor 140, and the ADS sensor 120 (an operation S420). Here, the control unit 200 sequentially sets the opening degree of the intake door 310 according to the priority of the ADS sensor 120, the VOC sensor 110, the CO₂ sensor 130, and the PM sensor 140 (an operation S421).

In a case where the control command for the opening degree of the intake door 310 through the ADS sensor 120 is applied, the control unit 200 controls the intake door 310 so that the intake door 310 has an opening degree output from the ADS sensor 120. In addition, when there is no control command for the opening degree of the intake door 310 through the ADS sensor 120, the control unit 200 controls the opening degree of the intake door 310 according to the control command for the opening degree of the intake door 310 through the VOC sensor 110 as a second priority. Further, in a case where there is no control command for the opening degree of the intake door 310 through the ADS sensor 120 and the VOC sensor 110, the control unit 200 controls the opening degree of the intake door 310 according to the control command for the opening degree of the intake door 310 through the CO₂ sensor 130.

Furthermore, in a case where there is no control command for the opening degree of the intake door 310 through the ADS sensor 120, the VOC sensor 110, and the CO₂ sensor 130, the control unit 200 controls the opening degree of the intake door 310 according to the control command for the opening degree of the intake door 310 through the PM sensor 140.

In this way, in the present embodiment, the opening degree of the intake door 310 is controlled according to the control commands for the opening degree of the intake door 310 in the order of the ADS sensor 120, the VOC sensor 110, the CO₂ sensor 130, and the PM sensor 140.

The present disclosure provides the method of operating, in a case where there are a plurality of control commands including conflicting controls or different operating levels, the HVAC system 300 by selecting one control command to improve air quality. The present disclosure may achieve the following effects.

According to the present disclosure, since an HVAC system is controlled by giving priority to air quality improvement among conflicting control commands, it is possible to achieve a comprehensive air quality improvement effect inside the vehicle.

In addition, it is possible to maintain a comfortable environment inside the vehicle by simultaneously detecting the concentration of CO₂, the concentration of VOC, the concentration of particulate matter, and relative humidity.

In the above description, some embodiments of the present disclosure have been described. The above description is intended to illustrate some embodiments of the present disclosure, and the present disclosure may be used in various other combinations, modifications, and environments. In other words, various changes or modifications can be made within the scope of the inventive concept disclosed in this specification, equivalents thereof, and/or within the scope of technology or knowledge in the art. The described embodiments merely illustrate the best mode for implementing the technical idea of the present disclosure, and various changes for specific application fields and uses of the present disclosure are also possible. Accordingly, the detailed description of the present disclosure above is not intended to limit the present disclosure to the disclosed embodiments. Additionally, the appended claims should be construed to include other embodiments as well.

What is claimed is:

1. An air quality control apparatus for a vehicle, the apparatus comprising:
a volatile organic compound (VOC) sensor configured to measure a concentration of volatile organic compounds inside the vehicle;
a CO₂ sensor configured to measure a concentration of CO₂ inside the vehicle;
a particulate matter (PM) sensor configured to measure a concentration of particulate matter inside the vehicle;
an auto defogging system (ADS) sensor configured to measure a humidity level inside the vehicle; and
a control unit configured to calculate an opening degree of an intake door, an operating level of a blower motor, and an operating level of an air conditioner, based on data measured from the ADS sensor, the VOC sensor, the CO₂ sensor, and the PM sensor, the control unit configured to control the opening degree of the intake door, the operating level of the blower motor, and the operating level of the air conditioner, according to priority of the opening degree of the intake door, the operating level of the blower motor, and the operating level of the air conditioner.

2. The apparatus according to claim 1, wherein when controlling the opening degree of the intake door selected based on the priority, the control unit is configured to set the priority in order of the ADS sensor, the VOC sensor, the CO₂ sensor, and the PM sensor to control the opening degree of the intake door.

3. The apparatus according to claim 2, wherein when controlling the opening degree of the intake door, the control unit is configured to sequentially determine the opening degree of the intake door in the order of the ADS sensor, the VOC sensor, the CO₂ sensor, and the PM sensor to control the intake door.

4. The apparatus according to claim 1, wherein when controlling the operating level of the blower motor selected based on the priority, the control unit is configured to perform control for maximizing the operating level of the blower motor based on the data measured from the ADS sensor, the VOC sensor, the CO₂ sensor, and the PM sensor.

5. The apparatus according to claim 1, wherein, when controlling the operation of the air conditioner selected based on the priority, the control unit is configured to operate the air conditioner in a case where there is at least one air conditioner-on request based on the data measured from the ADS sensor, the VOC sensor, and the PM sensor.

6. The apparatus according to claim 1, wherein when determining the priority based on the data measured from the ADS sensor, the VOC sensor, the CO₂ sensor, and the PM sensor, the control unit is configured to:
index the data measured from the ADS sensor, the VOC sensor, the CO₂ sensor, and the PM sensor, and
control the opening degree of the intake door, the operating level of the blower motor, and an on-off of the air conditioner based on the priority of the opening degree of the intake door, the operating level of the blower motor, and the operating level of the air conditioner.

7. A vehicle air quality control method, comprising:
operating a heating, ventilation, air conditioning (HVAC) system of a vehicle;
operating, by a control unit, a sensor unit;
receiving, by the control unit, data on a concentration of volatile organic compounds, a concentration of CO₂ inside the vehicle, a concentration of particulate matter inside the vehicle, and a humidity level inside the vehicle from the sensor unit; and
controlling, by the control unit, a blower, an air conditioner, and an opening degree of an intake door based on the received data.

8. The method according to claim 7, wherein operating the sensor unit comprises:
performing initialization of the sensor unit.

9. The method according to claim 7, wherein controlling the blower, the air conditioner, and the opening degree of the intake door comprises:
calculating, by the control unit, control values of the blower, the air conditioner, and the opening degree of the intake door based on the data received from the sensor unit; and
controlling, by the control unit, the blower, the air conditioner, and the opening degree of the intake door according to priority of the calculated control values.

10. The method according to claim 9,
wherein controlling the blower, the air conditioner, and the opening degree of the intake door according to the priority of the calculated control values, comprises:
sequentially determining control amounts of a blower motor respectively calculated based on data received from an auto defogging system (ADS) sensor, a volatile organic compound (VOC) sensor, a CO₂ sensor, and a particulate matter (PM) sensor, and performing control for allowing the blower motor to have a maximum operating level.

11. The method according to claim 9, wherein controlling the blower, the air conditioner, and the opening degree of the intake door according to the priority of the calculated control values, comprises:
sequentially determining the opening degree of the intake door according to priority of an auto defogging system (ADS) sensor, a volatile organic compound (VOC) sensor, a CO₂ sensor, and a particulate matter (PM) sensor, and performing control for providing the opening degree of the intake door according to the priority.

12. The method according to claim 11, wherein controlling the blower, the air conditioner, and the opening degree of the intake door according to the priority of the calculated control values, comprises:
operating the air conditioner in a case where there is at least one air conditioner-on request based on data received from the ADS sensor, the VOC sensor, and the PM sensor.
